(19) United States
(12) Patent Application Publication
(10) Pub. No.: US 2007/0014517 A1
(43) Pub. Date: Jan. 18, 2007

(54) Electromagnetic energy emitting device with increased spot size

(75) Inventors: Ioana M. Rizoiu, San Clemente, CA (US); Dmitri Boutoussov, Dana Point, CA (US)

Correspondence Address: Kenton R. Mullins;Stout, Uxa, Buyan & Mullins, LLP, Suite 300, 4 Venture, Irvine, CA, 92618, US

(73) Assignee: BioLase Technology, Inc., Irvine, CA (US)

(21) Appl. No.: 11/441,787

(22) Filed: May 25, 2006

Related U.S. Application Data
(60) Provisional application No. 60/684,296, filed on May 25, 2005.

(51) Int. Cl. G02B 6/42; G02B 6/26; F21V 11/00; G02B 5/02; F21V 7/04; G09F 13/00; H01J 5/16; H01P 5/00; G02B 6/00

(52) U.S. Cl. 385/45; 385/39; 385/42; 385/48; 385/50; 362/551; 362/558

(57) ABSTRACT

Outputs of a plurality of electromagnetic energy emitting devices are merged to create merged electromagnetic energy. The merged electromagnetic energy illuminates a target with a spot size larger than a spot size obtained with a single electromagnetic energy emitting device.

### CROSS-REFERENCE TO RELATED APPLICATIONS

This application claims the benefit of U.S. Provisional Application No. 60/684,296, filed May 25, 2005 and entitled ELECTROMAGNETIC ENERGY EMITTING DEVICE WITH INCREASED SPOT SIZE (Att. Docket BI9849PR), the entire contents of which are hereby incorporated by reference.

### BACKGROUND OF THE INVENTION

1. Field of the Invention

The present invention relates generally to electromagnetic energy emitting devices and, more particularly, to medical lasers.

2. Description of Related Art

A variety of electromagnetic energy generating device architectures have existed in the prior art. A solid-state laser system, for example, generally comprises a laser rod for emitting coherent light and a source for stimulating the laser rod to emit the coherent light. The coherent light, which may be referred to as a laser beam, may be delivered to a target surface through a fiber optic waveguide. Care must be exercised to assure that the laser beam possesses properties appropriate for performance of an intended function. Properties of a laser beam employed in cutting or removal of, for instance, dental tissue may differ from properties of a laser beam employed to coagulate blood in soft tissue. A laser beam may be described by its fluence or power density, which may in turn be measured in, for example, watts per square meter (W/m²), milliwatts per square centimeter (mW/cm²), or the like. Common practice has determined preferred values for fluence or power density levels depending upon procedures to be performed.

Patient comfort may be an important consideration in the use of medical laser devices in, for example, dental applications. A crucial aspect of patient comfort may include an amount of time required to perform a dental procedure. Generally, shorter procedure times may be preferred over longer procedure times. In some cases, a procedure time may be decreased by increasing a fluence or power density level of a laser beam. For example, the fluence or power density may be increased by increasing the power in the laser beam. However, increasing power may produce unpleasant odors that decrease patient comfort. Additionally, higher fluence or power density levels may result in higher temperatures associated with a procedure, which higher temperatures may result in increased pain for a patient or decreased quality in the outcome of the procedure.

A need thus exists in the prior art to increase laser power delivered to a treatment area without increasing the fluence or power density of the laser beam.

### SUMMARY OF THE INVENTION

The present invention addresses this need by providing a method of increasing size of an area of interest (e.g., spot size), the area of interest being illuminated by electromagnetic energy on a target (e.g., a tooth). An implementation of the method herein disclosed comprises providing a reference area on the target, whereby a reference electromagnetic energy emitting device is capable of illuminating the reference area with treatment electromagnetic energy having a reference power density. The treatment electromagnetic energy can have a wavelength that is suitable for treating (e.g., ablating) the reference area, which may comprise, for example, carries of a tooth. With references established, the implementation further provides a plurality of electromagnetic energy emitting devices capable of illuminating the reference area with treatment electromagnetic energy having the reference power density. Treatment electromagnetic energies emitted by the plurality of electromagnetic energy emitting devices are merged to create merged electromagnetic energy, which is directed to the target. According to an illustrated implementation, the area of interest is larger than the reference area and is illuminated by merged electromagnetic energy having a power density substantially equal to the reference power density.

The present invention further discloses an apparatus for increasing a size of an area of interest on a target illuminated by electromagnetic energy. An embodiment of the apparatus comprises a plurality of electromagnetic energy emitting devices capable of illuminating a reference area with treatment electromagnetic energy having a reference power density and a merging device capable of merging treatment electromagnetic energies emitted by the plurality of electromagnetic energy emitting devices, thereby creating merged electromagnetic energy. Another embodiment of the present invention comprises a medical laser device including a plurality of lasers capable of generating treatment laser beams that illuminate a reference area on a target with a reference power density. The treatment laser beams can have wavelengths that are suitable for treating (e.g., ablating) the reference area, which may comprise, for example, carries of a tooth. The embodiment further comprises a merging device capable of merging treatment laser beams generated by the plurality of lasers, thereby creating at least one merged laser beam.

While the apparatus and method has or will be described for the sake of grammatical fluidity with functional explanations, it is to be expressly understood that the claims, unless expressly formulated under 35 U.S.C. 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. 112 are to be accorded full statutory equivalents under 35 U.S.C. 112.

Any feature or combination of features described herein are included within the scope of the present invention provided that the features included in any such combination are not mutually inconsistent as will be apparent from the context, this specification, and the knowledge of one skilled in the art. For purposes of summarizing the present invention, certain aspects, advantages and novel features of the present invention are described herein. Of course, it is to be understood that not necessarily all such aspects, advantages or features will be embodied in any particular embodiment of the present invention. Additional advantages and aspects of the present invention are apparent in the following detailed description and claims that follow.

### BRIEF DESCRIPTION OF THE DRAWINGS

FIG. 1 is a block diagram of a prior art electromagnetic energy emitting device;

FIG. 2 is a pictorial diagram of one embodiment of an electromagnetic energy emitting device having an increased spot size according to the present invention;

FIG. 3 is a pictorial diagram of a modified embodiment of the present invention;

FIG. 4 is a pictorial diagram of an embodiment of the present invention that merges treatment-energy outputs of five electromagnetic energy sources;

FIG. 5A is a diagram illustrating two possible components of a merging device;

FIG. 5B is a pictorial diagram of an embodiment capable of merging outputs of four electromagnetic energy sources;

FIG. 5C is a diagram of a portion of the embodiment of FIG. 5B illustrating use of defocusing optics to obtain an increased spot size;

FIG. 6 is a flow diagram of an implementation of a method of increasing a size of an area of interest according to the present invention;

FIG. 7 is a pictorial diagram of a delivery system capable of transferring electromagnetic energy to a treatment site in accordance with an example of the present invention;

FIG. 8 is a pictorial diagram illustrating detail of a connector according to an example of the present invention;

FIG. 9 is a perspective diagram of an embodiment of module that may connect to a laser base unit and that may accept the connector illustrated in FIG. 8;

FIG. 10 is a front view of the embodiment of the module illustrated in FIG. 9;

FIG. 11 is a cross-sectional view of the module illustrated in FIG. 10, the cross-section being taken along a line 11-11′ of FIG. 10;

FIG. 12 is another cross-sectional view of the module illustrated in FIG. 10, the cross-section being taken along a line 12-12′ of FIG. 10;

FIG. 13 is a pictorial diagram of an embodiment of the conduit shown in FIG. 7;

FIG. 14 is a partial cut-away diagram of a handpiece tip in accordance with an example of the present invention;

FIG. 14a is a pictorial diagram of detail of the handpiece tip of FIG. 14 illustrating a mixing chamber for spray air and water;

FIG. 15 is a sectional view of a proximal member of FIG. 13 taken along line 15-15′ of FIG. 13;

FIG. 16 is a cross-sectional view of a handpiece tip taken along line 16-16′ of FIG. 14;

FIG. 17 is a cross-sectional diagram of another embodiment of the handpiece tip taken along the line 16-16′ of FIG. 14; and

FIG. 18 is a cross-sectional diagram of an implementation of an embodiment of the laser handpiece tip taken along line 18-18′ of FIG. 14.

### DETAILED DESCRIPTION OF THE PRESENTLY PREFERRED EMBODIMENTS

Reference will now be made in detail to the presently preferred embodiments of the invention, examples of which are illustrated in the accompanying drawings. Wherever possible, the same or similar reference numbers are used in the drawings and the description to refer to the same or like parts. It should be noted that the drawings are in simplified form and are not to precise scale. In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

Although the disclosure herein refers to certain illustrated embodiments, it is to be understood that these embodiments are presented by way of example and not by way of limitation. The intent of the following detailed description, although discussing exemplary embodiments, is to be construed to cover all modifications, alternatives, and equivalents of the embodiments as may fall within the spirit and scope of the invention as defined by the appended claims. It is to be understood and appreciated that the process steps and structures described herein do not cover a complete process flow for the manufacture and operation of electromagnetic energy generating devices. The present invention may be practiced in conjunction with various laser device fabrication and operation methods that are conventionally used in the art, and only so much of the commonly practiced process steps are included herein as are necessary to provide an understanding of the present invention. The present invention has applicability in the field of electromagnetic energy generating devices and processes in general. For illustrative purposes, however, the following description pertains to a medical laser device and to methods of increasing a spot size of medical lasers.

The present invention relates to electromagnetic energy emitting devices, such as lasers, for treating tissues. Particular electromagnetic energy emitting devices that may be used in connection or combination with the present invention include, for example, tissue-ablating medical lasers, such as relatively high-power Erbium type lasers and other lasers having wavelengths that are absorbed relatively highly by, for example, water. Examples of laser configurations (e.g., configurations including fluid components and uses) and methods are disclosed in U.S. application Ser. No. 11/330,388, filed Jan. 10, 2006 and entitled FLUID CONDITIONING SYSTEM (Att. Docket BI9914P), U.S. application Ser. No. 11/033,032, filed Jan. 10, 2005 and entitled ELECTROMAGNETIC ENERGY DISTRIBUTIONS FOR ELECTROMAGNETICALLY INDUCED DISRUPTIVE CUTTING (Att. Docket BI9842P), U.S. application Ser. No. 11/203,677, filed Aug. 12, 2005 and entitled LASER HANDPIECE ARCHITECTURE AND METHODS (Att. Docket BI9806P), and U.S. application Ser. No. 11/203,400, filed Aug. 12, 2005 and entitled DUAL PULSE-WIDTH MEDICAL LASER WITH PRESETS (Att. Docket BI9808P), the entire contents of all which are incorporated herein by reference.

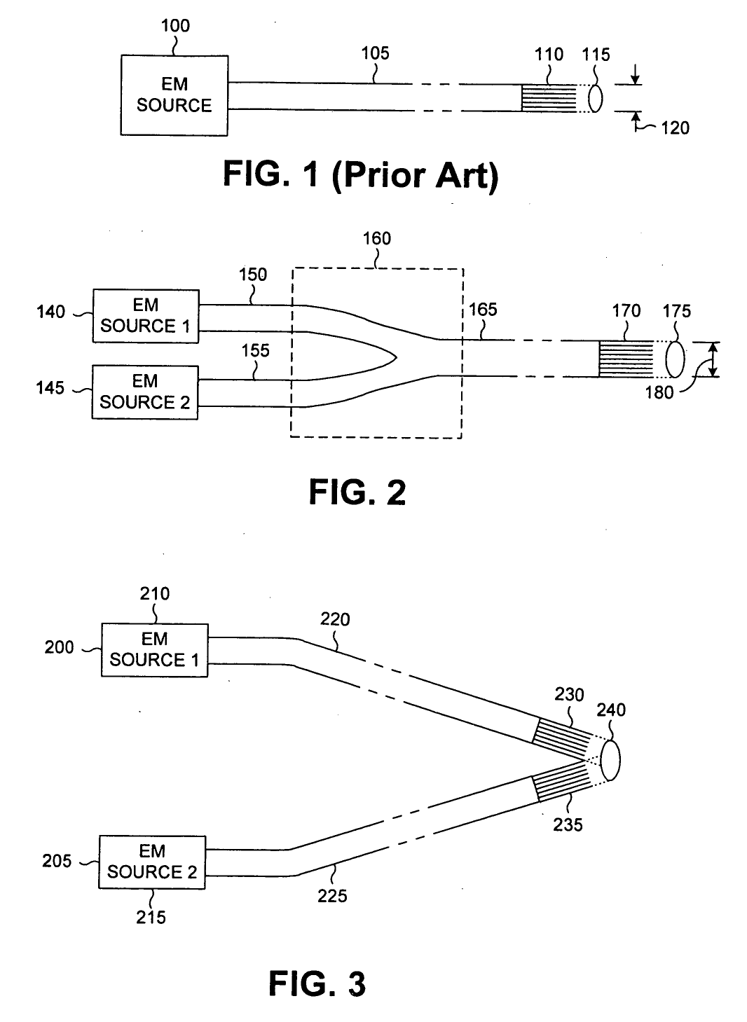

Referring more particularly to the drawings, FIG. 1 is a block diagram of a prior-art electromagnetic energy emitting device, which may be, for example, a medical laser device. The illustrated embodiment comprises an electromagnetic energy source 100, which may be, for example, a medical laser. The electromagnetic energy source 100 may generate electromagnetic energy at a reference power level that is coupled to a waveguide 105 having a reference cross-sectional area, the waveguide being capable of directing the electromagnetic energy to a target, e.g., a target surface. For example, a laser beam 110 may be emitted from an output of the waveguide 105 and directed to a spot 115 on a target surface, the spot 115 having a reference area related to a reference diameter 120. The spot 115 may represent an area of interest that is illuminated by the electromagnetic energy on the target surface. The electromagnetic energy may illuminate the area of interest on the target surface with a reference fluence or power density measured, for example, in milliwatts per square centimeter (mW/cm²). The prior-art configuration illustrated in FIG. 1 may be referred to herein as a pre-configuration electromagnetic energy emitting device, where the term “pre-configuration” is intended to mean not configured according to the present invention or, for example, not configured as part of a merged-output system. As such, the prior art configuration provides a reference against which the present invention may be compared. That is, the prior art configuration illustrated in FIG. 1 provides a reference power level for an electromagnetic energy source, a reference cross-sectional area for a waveguide, and a reference fluence or power density for electromagnetic energy that illuminates a spot having a reference area on a target surface. The reference fluence or power density can correspond to that of a single electromagnetic energy emitting device outputting, for a similar procedure, treatment (e.g., ablating) energy into a single waveguide, which does not have an increased diameter to accommodate simultaneously energies from multiple electromagnetic energy emitting devices and which does not simultaneously carry treatment (e.g., ablating) energy from any other electromagnetic energy emitting devices. In a particular instance, the diameter of the waveguide can be selected to provide a fluence or power density, within or at the output of the waveguide, that would correspond to or equal a reference fluence or power density used for a procedure, as measured within or at the output of a reference waveguide, respectively, from a single one of the electromagnetic energy emitting devices implementing the procedure in isolation or in a non-merged mode of operation.

As used herein, a conventional or non-merged mode of operation corresponds to uses of electromagnetic energy emitting devices wherein treatment outputs from the electromagnetic energy emitting devices: are not simultaneously merged or combined together, such as, for example, implementations wherein a number of waveguides accepting treatment-energy outputs from the electromagnetic energy emitting devices is equal to the number of electromagnetic energy emitting devices; are not of the same wavelength; and/or, for example, are not of the same treatment function (e.g., one for a coagulating function and one for an ablating function).

According to an aspect of the present invention, treatment-energy outputs from a plurality of electromagnetic energy emitting devices can be combined or merged into one waveguide (e.g., one fiber optic and/or output tip), or into a relatively small number of waveguides compared to the number of electromagnetic energy emitting devices. For instance, a merged output system according to the present invention can comprise treatment-energy outputs from two electromagnetic energy emitting devices (e.g., identical electromagnetic energy emitting devices, such as identical lasers) merged into a single waveguide. As provided herein, the term treatment, such as used, for example, in the context of treatment energies, treatment electromagnetic energies, treatment beams or treatment outputs, refers to energies, beams or outputs which are all substantially the same in function to be performed on the target (e.g., all for ablating or all for coagulating) or in wavelength.

The pictorial diagram of FIG. 2, for instance, shows one embodiment of an electromagnetic energy emitting device having an increased spot size according to the present invention. The illustrated embodiment comprises first and second electromagnetic energy sources designated, respectively, by reference numbers 140 and 145, which electromagnetic energy sources may be, for example, medical lasers. The first electromagnetic energy source 140 generates treatment electromagnetic energy (e.g., a tissue ablating laser beam) at a reference power level and is coupled into a first waveguide 150, which may, in the illustrated embodiment, have a cross-sectional area equal to the reference cross-sectional area mentioned above with reference to the waveguide 105 in FIG. 1. Similarly, the second electromagnetic energy source 145 generates treatment electromagnetic energy at the reference power level and is coupled to a second waveguide 155 which, likewise, may have a cross-sectional area equal to the reference cross-sectional area. The first and second electromagnetic energies can have a wavelength/wavelengths that is/are suitable for treating (e.g., for ablating, as distinguished from just illuminating) the reference area, which may comprise, for example, hard (e.g., a tooth) or soft (e.g., gingiva) tissue.

The first waveguide 150 and second waveguide 155 are merged in a merging device 160 illustrated symbolically in FIG. 2 by a phantom-lined box. Treatment electromagnetic energy entering the merging device 160 through first waveguide 150 and second waveguide 155 exits the merging device 160 through a third waveguide 165, the third waveguide 165 having a cross-sectional area substantially greater than (e.g., 1.1 or more times greater than, such as twice that of) the reference cross-sectional area. A beam of merged electromagnetic energy 170 exits the third waveguide and illuminates a spot 175 comprising an area of interest on a target, e.g., a target surface. The spot 175 may have a diameter 180 greater than the reference diameter 120 (FIG. 1). According to an exemplary embodiment, the diameter 180 is about 1.414 times as large as the reference diameter.

A modified embodiment of the present invention is illustrated in the block diagram of FIG. 3. The illustrated embodiment comprises first and second electromagnetic energy sources 200 and 205, which emit treatment electromagnetic energy at the reference power level, the treatment electromagnetic energy being coupled into respective waveguides 220 and 225. The waveguides 220 and 225 may be flexible, and each may be capable of directing treatment electromagnetic energy to a target, e.g., a target surface. In the example shown in FIG. 3, first waveguide 220 directs treatment electromagnetic energy 230 onto a target surface. Likewise, second waveguide 225 directs treatment electromagnetic energy 235 onto the same target surface. The treatment electromagnetic energies 230 and 235 thereby form merged electromagnetic energy at the target surface. The merged electromagnetic energy may illuminate a spot 240, i.e., an area of interest, the area of which may be substantially greater than (e.g., 1.1 times to twice) the reference area. The fluence or power density of the merged electromagnetic energy may be substantially the same as the reference fluence or power density, considering that the power in the merged electromagnetic energy is about twice the reference power and is distributed over about twice the reference area.

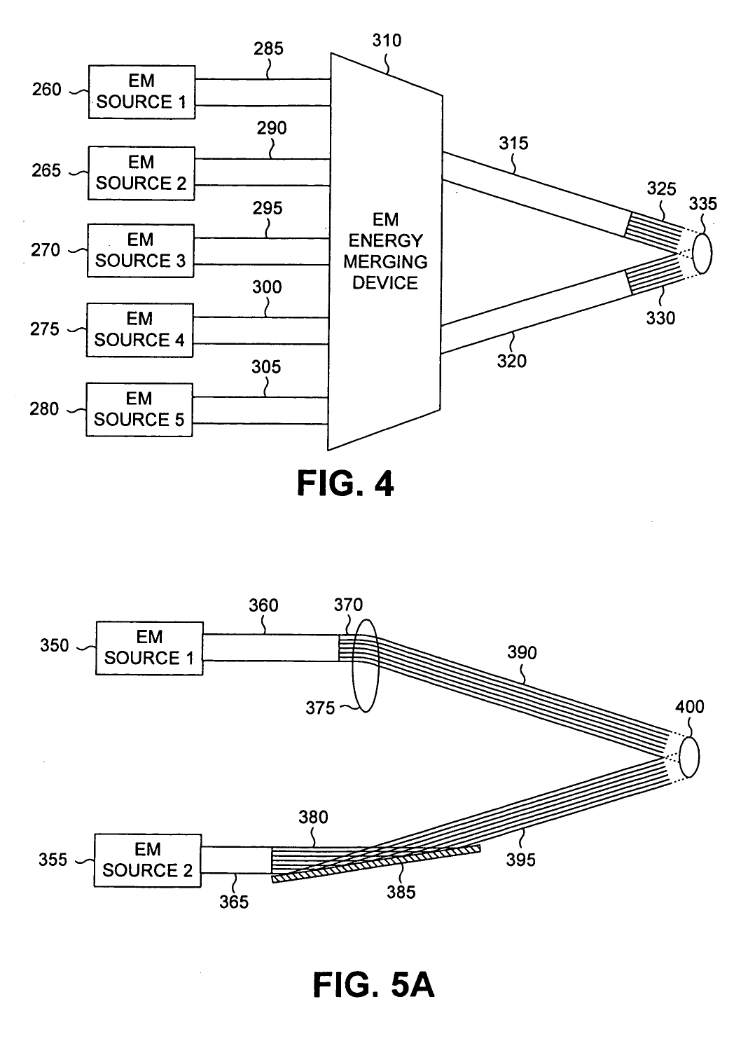

Additional embodiments of the present invention will occur to one skilled in the art in view of the examples already presented. In general, any number of treatment-energy outputs of electromagnetic energy sources may be merged together to form a merged-output electromagnetic energy emitting device capable of illuminating an area of interest, e.g., a spot, having an area larger than the reference area with electromagnetic energy having a fluence or power density that is substantially the same as the reference power density. For example, an embodiment as shown in FIG. 4 can comprise a plurality (e.g., three, four, five, or more) of electromagnetic energy sources. In the illustrated embodiment of FIG. 4, five such electromagnetic energy sources 260, 265, 270, 275, and 280 generate treatment electromagnetic energy at the reference power level. The generated treatment electromagnetic energies are coupled to respective waveguides 285, 290, 295, 300, and 305 having, according to an exemplary embodiment, cross-sectional areas equal to the reference cross-sectional area. Treatment electromagnetic energies from the waveguides 285, 290, 295, 300, and 305 are coupled to an electromagnetic energy merging device 310 having five treatment-energy inputs and two outputs.

The two outputs couple the electromagnetic energy (e.g., treatment electromagnetic energy) to first and second output waveguides 315 and 320, having cross-sectional areas larger than the reference cross-sectional area. For example, first and second output waveguides 315 and 320 may have cross-sectional areas equal to about 5/2 the reference cross-sectional area. In a manner similar to that described above in the discussion of FIG. 3, first and second output waveguides 315 and 320 may direct at least a portion of the electromagnetic energy (e.g., treatment electromagnetic energy) emerging from the electromagnetic energy merging device 310 to a target. That is, first output waveguide 315 may direct a first beam 325 of electromagnetic energy to the target, and second output waveguide 320 may direct a second beam 330 of electromagnetic energy to the target. The arrangement just described has an effect of merging treatment electromagnetic energy from the five electromagnetic energy sources 260, 265, 270, 275, and 280 at a spot 335 on a target. In some embodiments the merging may occur on a target surface or within the target. The spot 335, which may be referred to as an area of interest, may have an area about five times as large as the reference area in the illustrated embodiment.

A modified form of the embodiment illustrated in FIG. 4 comprises a single output waveguide (e.g., first output waveguide 315), which directs merged electromagnetic energy, corresponding to (e.g., including) the first beam 325 and the second beam 330, to the target. In another modified embodiment, outputs from the electromagnetic energy emitting devices (e.g., defining a merged-output system and/or forming an enhanced-fluence or -power output) are combined or merged together on or within a target, without the use of waveguides and/or electromagnetic energy merging device 310, using optics such as lenses and/or reflecting surfaces. Outputs from the electromagnetic energy emitting devices (e.g., defining a merged-output system and/or forming the enhanced-fluence or -power output) of another modified embodiment are combined or merged together, without the use of waveguides and/or electromagnetic energy merging device 310, using optics such as lenses and/or reflecting surfaces, and subsequently routed and directed to a target (e.g., without the use of waveguides and using optics such as lenses and/or reflecting surfaces).

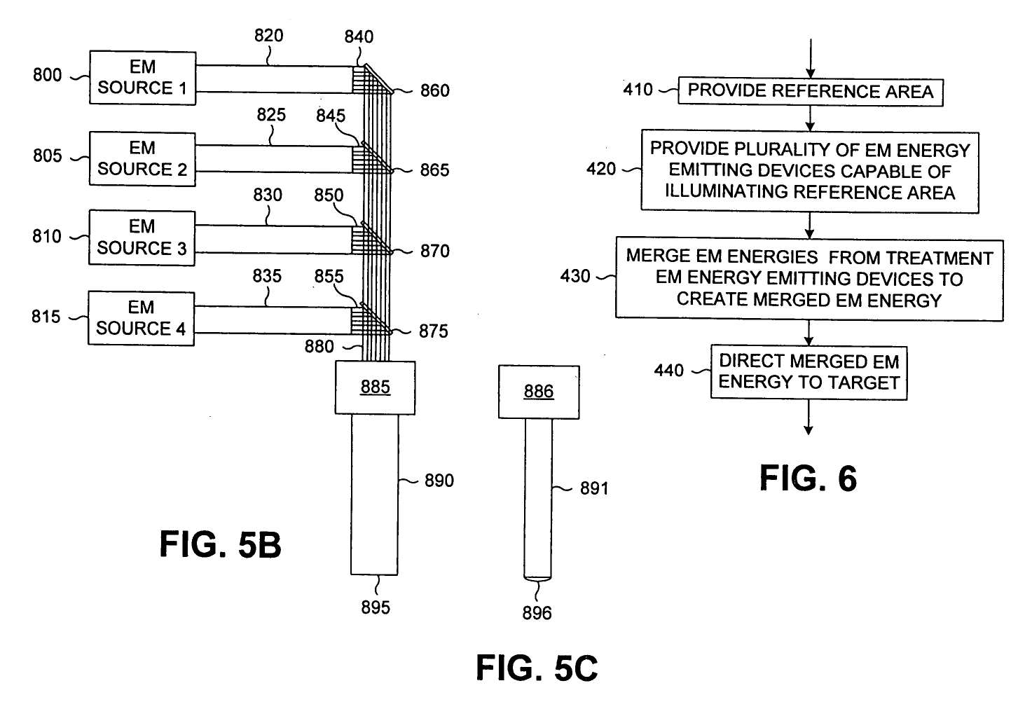

FIG. 5A illustrates two possible components of an apparatus capable of merging, in this example, two treatment electromagnetic energy beams of energy. An embodiment shown in FIG. 5A comprises a first electromagnetic energy source 350 and a second electromagnetic energy source 355. Treatment electromagnetic energy from the first electromagnetic energy source 350 is emitted at the reference power level and is directed to a first waveguide 360 having a reference cross-sectional area. Likewise, treatment electromagnetic energy from the second electromagnetic energy source 355 is also emitted at the reference power level and is directed to a second waveguide 365 having a reference cross-sectional area. Treatment electromagnetic energy 370, which may form a beam at an output of the first waveguide 360, is directed to a convex lens 375, which may act to redirect the treatment electromagnetic energy 370 into a beam 390 that may illuminate a portion of a spot 400 on a target surface. At the same time, treatment electromagnetic energy 380, which may form a beam at an output of the second waveguide 365, is directed to a reflecting surface, e.g., a mirror 385, which may act to redirect the treatment electromagnetic energy 380 into a treatment beam 395 that also may illuminate a portion of the spot 400 on the target surface. Beam 390 and beam 395 are thereby merged at the target surface to form merged electromagnetic energy. According to a typical example, the spot 400 can have, for example, an area about twice the reference area, and the fluence or power density of the merged electromagnetic energy is about the same as the reference power density.

Another embodiment of the present invention is illustrated in FIG. 5B wherein treatment electromagnetic energies from two or more (e.g., four) electromagnetic energy sources are merged. The illustrated embodiment comprises respective first, second, third, and fourth electromagnetic energy sources 800, 805, 810, and 815, forming, respectively, first, second, third, and fourth beams 840, 845, 850, and 855 at outputs of respective first, second, third, and fourth waveguides 820, 825, 830, and 835. The first, second, third, and fourth waveguides 820, 825, 830, and 835 may have reference cross-sectional areas, and the electromagnetic energy sources 800, 805, 810, and 815 may generate treatment electromagnetic energy having a reference fluence (or fluences) or power density (or power densities). Treatment electromagnetic energy generated by first electromagnetic energy source 800, i.e., first beam 840, is directed to a first diverting (e.g., reflective) device 860 having a diverting (e.g., reflective) surface that directs at least a portion of the first beam 840 toward optics 885. The first beam may be directed through, but in modified embodiments is not required to be directed through, any one or more of respective second, third, and fourth reflective devices 865, 870, and 875, whereby a portion of a merged beam 880 of treatment electromagnetic energy is formed that is incident upon optics 885. Respective second, third, and fourth diverting (e.g., reflective) devices 865, 870, and 875 may be configured similarly to the diverting device 860.

Thus, for example, in embodiments wherein one or more of the optical paths from the first, second, third, and fourth diverting devices 860, 865, 870, and 875 overlap, any one or more of the second, third, and fourth diverting devices 865, 870, and 875 can be configured to be capable of transmitting at least a portion of downward-directed treatment electromagnetic energy (e.g., the reflected portion of first beam 840) toward optics 885 as illustrated in FIG. 5B. Treatment electromagnetic energy generated by second electromagnetic energy source 805, i.e., second beam 845, can be directed to the second diverting device 865, which, likewise, can have a reflective surface that directs at least a portion of the second beam 845 toward optics 885, for example, through third diverting device 870 and fourth diverting device 875, thereby forming an additional portion of the merged beam 880 of electromagnetic energy. Similarly, treatment electromagnetic energies generated by the third and fourth electromagnetic energy sources 810 and 815, i.e., third and fourth beams 850 and 855, can be directed toward third and fourth diverting devices 870 and 875, which can direct at least portions of third and fourth beams 850 and 855 toward optics 885, thereby forming further additional portions of the merged beam 880.

The optics 885 illustrated in FIG. 5B may comprise a typical convex lens or comparable structure capable of directing the merged beam 880 of treatment electromagnetic energy to a waveguide 890 having a cross-sectional area which may be, for example, greater than the reference cross-sectional area. Typically, the merged beam 880 exits the waveguide 890 at a planar output end 895, thereby producing a spot size on a target that is larger than the reference spot size with the same as, or substantially the same as, a reference fluence or power density.

FIG. 5C illustrates a portion of an embodiment similar to that shown in FIG. 5B, but with modified optics 886, corresponding to optics 885, capable of directing the merged beam 880 to a waveguide 891 having, for example, a reference cross-sectional area. Material used to form modern waveguides (e.g., waveguide 891) may be capable of transmitting the merged beam 880 of electromagnetic energy, which, typically, has power higher than the reference power. In the illustrated embodiment, the merged beam 880 exits the waveguide 891 through defocusing optics 896 capable of spreading the merged beam 880 to create an increased spot size on a target as described herein.

According to the present invention, merged-output systems are provided having relatively large spot sizes and relatively constant (e.g., unchanged) fluences or power densities, such as, for example, fluences or power densities corresponding to those of any one or more of the pre-configuration electromagnetic energy emitting devices that form a merged-output system. In typical implementations, the fluence or power density of the output of a merged-output system is about the same as any one or more individual fluences or power densities of the treatment electromagnetic energies of the individual electromagnetic energy emitting devices forming the merged-output system.

An aspect of the present invention comprises a method of increasing a size of an area of interest wherein the area of interest is on a target, e.g., a target surface, and is illuminated by electromagnetic energy. FIG. 6 illustrates an implementation of the method wherein a reference area is provided at step 410. One example of a reference area is illustrated in FIG. 1, wherein a spot 115, which may represent the reference area, is illuminated by a electromagnetic energy from an electromagnetic energy source 100 that supplies electromagnetic energy at a reference power level. In the instance described, the reference area is thereby illuminated with electromagnetic energy having a reference fluence or power density.

The implementation of the method illustrated in FIG. 6 continues at step 420 by providing a plurality of electromagnetic energy emitting devices capable of illuminating the reference area with treatment electromagnetic energies having the reference fluence or power density. Examples of the providing are described above in the discussion pertaining to FIGS. 2-5. For example, two electromagnetic energy emitting devices are provided in the embodiments illustrated in FIGS. 2, 3, and 5; five such devices are provided in the embodiment illustrated in FIG. 4. Treatment electromagnetic energies emitted by the provided electromagnetic energy emitting devices are merged at step 430 of the implementation, thereby creating merged electromagnetic energy.

Several types of apparatus are illustrated herein that are capable of merging the emitted electromagnetic energies. For example, FIG. 2 illustrates a merging device 160 wherein electromagnetic energies are merged by directing electromagnetic energy to first and second waveguides 150 and 155, which have reference cross-sectional areas and by causing the electromagnetic energies to exit the merging device through a third waveguide 165 having a cross-sectional area larger than the reference cross-sectional area. In the illustrated embodiment, the larger cross-sectional area can be, for example, about 1.1 or more times greater than, such as twice that of, the reference cross-sectional area. Another implementation of a method of merging electromagnetic energies may be implemented according to an apparatus as illustrated in FIG. 3. Merging in the illustrated instance occurs at a target surface, which has directed thereon treatment electromagnetic energy from electromagnetic energy sources 200 and 205. An embodiment illustrated in FIG. 5A demonstrates yet another apparatus capable of implementing the merging of step 430. In the embodiment of FIG. 5A, merging is again accomplished at a target surface, after beams of electromagnetic energy 370 and 380 are redirected by, respectively, a convex lens 375 and a mirror 385 to illuminate a spot 400 on the target surface, wherein the area of the spot 400 can be, for example, about twice the reference area and wherein the fluence or power density of the electromagnetic energy (i.e., the merged electromagnetic energy) illuminating the spot 400 can be about the same as the reference power density. In a modified embodiment, a convex lens may replace the mirror 385 in the embodiment illustrated in FIG. 5A. In yet another modified embodiment, a mirror may replace the convex lens 375. Other combinations of methods of electromagnetic energy merging are described above with reference to FIG. 4.

In embodiments wherein outputs from a plurality of electromagnetic energy emitting devices are directed into the same waveguide, the diameter of the waveguide can be selected to provide a fluence or power density corresponding to that which typically would be generated without the combining of treatment outputs from multiple electromagnetic energy emitting devices into waveguides of reduced numbers (e.g., numbers less than the number of electromagnetic energy emitting devices). For instance, the diameter of a waveguide carrying merged treatment beams of a merged-output system can be selected (e.g., increased) to provide a fluence or power density that is about the same as a reference fluence or power density, which is typical or suitable for a procedure being implemented, so that in accordance with an aspect of the present invention multiple electromagnetic energy emitting device treatment outputs are merged to provide a larger spot size for the same approximate fluence or power density. For the performance of a given procedure, the waveguide diameter may be selected to generate a fluence or power density that is about the same as a reference fluence or power density, which would be recognized as suitable for the performance of the procedure by one skilled in the art if the procedure were implemented using a single one of the electromagnetic energy emitting devices outputting treatment energy into a single waveguide (e.g., in a conventional or non-merged mode of operation). According to another aspect, for the performance of a given procedure, the waveguide diameter for carrying a merged beam in a merged-output system may be selected to generate a fluence or power density that is about the same as a reference fluence or power density, which would be generated by a single one of the electromagnetic energy emitting devices (of a merged-output system), outputting treatment energy into a single waveguide and operating at the same settings as used by that electromagnetic energy emitting device when operated as a part of the merged-output system during the given procedure.

Returning to FIG. 6, the merged electromagnetic energy is directed to a target, e.g., a target surface, at step 440. According to some embodiments, the merging of treatment electromagnetic energies occurs at a target surface as illustrated in the examples shown in FIGS. 3-5. In other instances, the merging occurs in a merging device whence the merged energy is directed to the target surface. An exemplary merging-device implementation is shown in FIG. 2, in which electromagnetic energies are merged in waveguides and/or a merging device as described herein. In other embodiments, optics, which may include lenses and/or reflecting surfaces may be used to accomplish the merging. Some embodiments (cf. FIG. 2) may employ one or more waveguides to direct merged electromagnetic energy to a target surface, and other embodiments (cf. FIG. 5A) may direct the merged electromagnetic energy to the target surface without use of waveguides.

Using a merged-output system in accordance with the present invention to generate a relatively large spot size may facilitate, for example, removal of more of a target (e.g., tissue) per unit of time. In exemplary embodiments, a merged output system is provided by combining and/or merging together, at least partially, outputs from a number of electromagnetic energy emitting devices (e.g., laser heads), to thereby generate an enhanced-fluence or -power output, which can then be directed through a waveguide system that comprises a fewer number of waveguides than the number of electromagnetic energy emitting devices.

Implementations of the present invention can comprise forming any combination or permutation of (1) any of the pre-configuration electromagnetic energy emitting devices described or incorporated by reference herein, and/or (2) any other pre-configuration electromagnetic energy emitting devices, to provide merged-output systems that have relatively large spot sizes and substantially unchanged fluences or power densities relative to the spot sizes, fluences and/or power densities of the pre-configuration electromagnetic energy emitting devices.

In one modified aspect of the present invention, wherein treatment outputs, beams or energies are not all the same in function or wavelength, merging various electromagnetic energy emitting device outputs into a reduced number of waveguides, while leaving fluences or power densities substantially unchanged, may be implemented to generate combinations of properties of the individual electromagnetic energy emitting devices into a single, simultaneous effect on the target surface. For example, one such modified configuration may employ a combination of a first beam having a tissue cutting wavelength and a second beam having a coagulating wavelength that may enhance the coagulation of blood.

In another modified aspect, according to one of a multitude of possible implementations, one or more erbium, chromium, yttrium, scandium, gallium, garnet (Er, Cr:YSGG) solid state lasers having a wavelength, which may be referred to as an A-wavelength, ranging from about 2.70 to 2.80 microns (e.g., about 2.78 microns) may be combined with, for example, one or more chromium, thulium, erbium, yttrium, aluminum garnet (CTE:YAG) solid state lasers having a wavelength, which may be referred to as a B-wavelength, of about 2.69 microns. In another modified implementation, one or more erbium, yttrium, aluminum garnet Er:YAG solid state lasers having a wavelength, which may be referred to as a C-wavelength, of about 2.94 microns may be combined with, for example, one or more chromium, thulium, erbium, yttrium, aluminum garnet (CTE:YAG) solid state lasers having a wavelength of about 2.69 microns.

In embodiments wherein the electromagnetic energy emitting devices comprise lasers, a plurality of laser cavities may be provided. The number of laser cavities may correspond, for example, to a number of lasers used. Various combinations and permutations of any of the electromagnetic energy emitting devices described or incorporated by reference herein, and/or other electromagnetic energy emitting devices, may be merged to provide output (i.e., merged output) energy distributions having, for example, unchanged fluences or power densities and increased spot sizes. In accordance with one aspect of the present invention, electromagnetic energy emitting devices having the same or substantially the same wavelength are combined to provide output energy distributions of about the same fluence or power density as before the combinations (e.g., as with conventional or non-merged modes of operation) but with increased spot sizes.

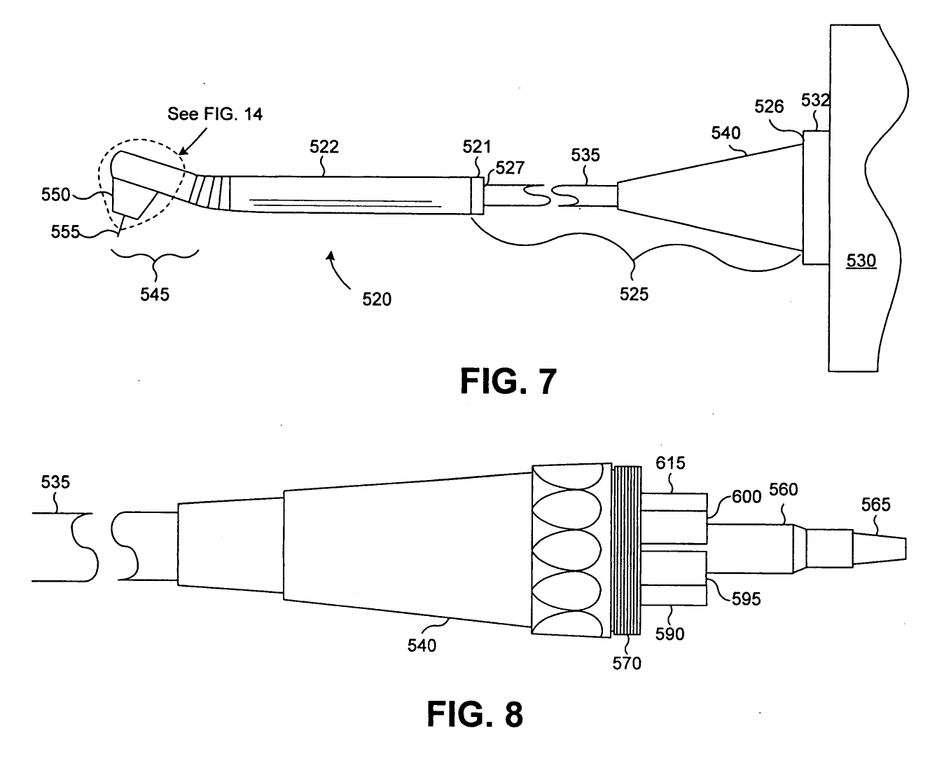

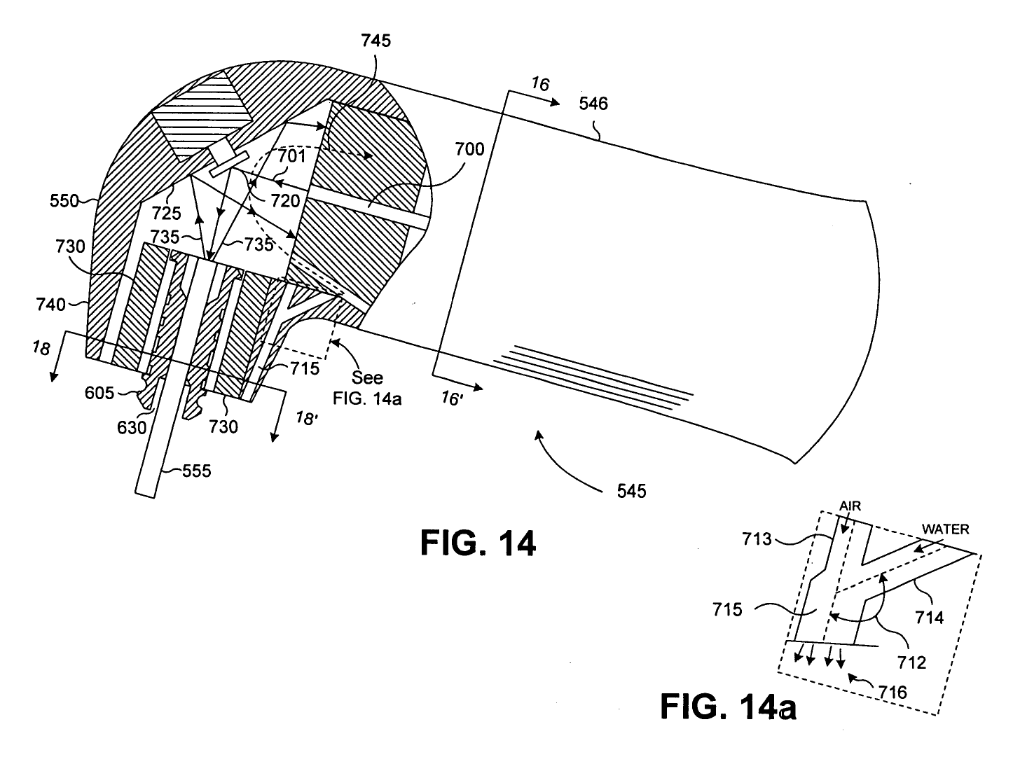

This invention can be applied to various electromagnetic energy emitting device configurations and methods, such as disclosed, for example, in connection with an identification connector described in a co-pending U.S. application Ser. No. 11/186,619, filed Jul. 20, 2005 and entitled CONTRA-ANGLE ROTATING HANDPIECE HAVING TACTILE-FEEDBACK TIP FERRULE (Att. Docket BI9798P), the contents of which are incorporated herein by reference. Referring to FIG. 7, a delivery system capable of transferring electromagnetic energy, such as laser energy, to a treatment site is depicted. The illustrated embodiment comprises a laser handpiece 520 that connects to an electromagnetic energy source housed in, for example, a laser base unit 530 using a linking element 525. According to an exemplary embodiment, the laser base unit 530 may comprise a plurality of electromagnetic energy sources (e.g., lasers) that generate treatment electromagnetic energy at a reference power level. Treatment electromagnetic energies emitted by the electromagnetic energy sources may be merged and coupled into the linking element 525. The linking element 525 may comprise a conduit 535, which may include one or more optical fibers capable of carrying treatment and/or merged electromagnetic energy as described herein, tubing for air, tubing for water, and the like. The linking element 525 further may comprise a connector 540 that joins the conduit 535 to the laser base unit 530. The connector 540 may be an identification connector as is described more fully in a co-pending U.S. application Ser. No. 11/192,334, filed Jul. 27, 2005 and entitled IDENTIFICATION CONNECTOR FOR A MEDICAL LASER HANDPIECE (Att. Docket BI9802P), the entire contents of which are incorporated herein by reference. For example, the identification connector may facilitate the discernment of whether a relatively large spot-size (e.g., merged output) of electromagnetic energy will be output or whether a standard spot size will be output. The laser handpiece 520 may comprise an elongate portion 522 and a handpiece tip 545, the elongate portion 522 having disposed therein a plurality of optical fibers that may connect to, or that are the same as the optical fibers included in the conduit 535. A proximal (i.e., relatively nearer to the laser base unit 530) portion 521 and a distal (i.e., relatively farther from the laser base unit 530) portion 550 may be disposed at respective proximal and distal ends of the laser handpiece 520. The distal portion 550 has protruding therefrom a fiber tip 555, which is described below in more detail with reference to FIG. 14. As illustrated, the linking element 525 has a first end 526 and a second end 527. The first end 526 couples to a receptacle 532 of the laser base unit 530, and the second end 527 couples to the proximal portion 521 of the laser handpiece 520. The connector 540 may connect mechanically to the laser base unit 530 with a threaded connection to the receptacle 532 that forms part of the laser base unit 530.

An embodiment of a connector 540 is illustrated in greater detail in FIG. 8. The illustrated embodiment comprises a laser beam delivery guide connection 560 that may comprise, for example, a treatment optical fiber 565 capable of transmitting laser energy to the laser handpiece 520 (FIG. 7). According to embodiments as described herein, the treatment optical fiber 565 may have a cross-sectional area larger than that normally employed in such devices in order to accommodate transmitting merged electromagnetic (e.g., laser) energy from a plurality of electromagnetic energy sources disposed in the laser housing 530 and coupled to the treatment optical fiber 565 according to the present invention. The illustrated embodiment further comprises a plurality of ancillary connections comprising, in this example, a feedback connection 615, an illumination light connection 600, a spray air connection 595, and a spray water connection 590, that may connect to the laser base unit 530 (FIG. 7). The plurality of ancillary connections further may comprise connections not visible in FIG. 8 such as an excitation light connection and a cooling air connection.

The embodiment of the connector 540 illustrated in FIG. 8 further comprises a threaded portion 570 that may mate with and thereby provide for connection to the receptacle 532 on the laser base unit 530 (FIG. 7).

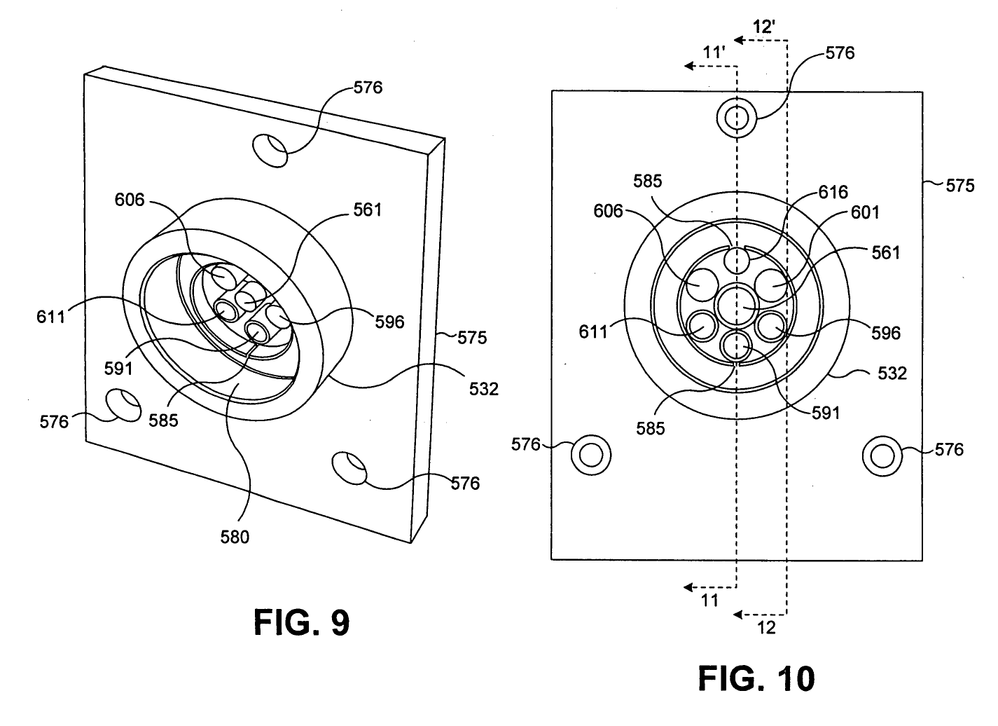

FIG. 9 is a perspective diagram of an embodiment of a module that may connect to, and form a part of an electromagnetic energy source (for example, the laser base unit 530 illustrated in FIG. 7) and that further may accept connector 540 (FIG. 8). The illustrated embodiment comprises a plate 575 that may fasten to the laser base unit 530 (FIG. 7) using, for example, screws inserted into holes 576. The module comprises a receptacle 532 that may be threaded on an inside surface 580 to mate with threads 570 on the connector 540 (FIG. 8). (Threads are not shown in FIG. 9.) The embodiment of the module further comprises a laser energy coupling 561 mated to the laser beam delivery guide connection 560 (FIG. 8), the laser energy coupling 561 being capable of providing laser energy to the delivery system. The embodiment further comprises a plurality of ancillary couplings including a spray air coupling 596, a spray water coupling 591, a cooling air coupling 611, and an excitation light coupling 606. The embodiment still further comprises a feedback coupling and an illumination light coupling that are not visible in the diagram. One or more key slots 585 may be included to assure that the connector 540 connects to the receptacle 532 in a correct orientation.

FIG. 10 is a front view of the embodiment of the module illustrated in FIG. 9. The view in FIG. 10 illustrates the plate 575 and the holes 576 that may be used to secure the plate module to an electromagnetic energy source, such as the laser base unit 530 illustrated in FIG. 7. Further illustrated are the laser energy coupling 561, feedback coupling 616, the illumination light coupling 601, the spray air coupling 596, the spray water coupling 591, the cooling air coupling 611, and the excitation light coupling 606. In operation, the spray water coupling 591 mates with and is capable of supplying spray water to the spray water connection 590 in the connector 540 (FIG. 8). Similarly, the spray air coupling 596 mates with and is capable of supplying spray air to the spray air connection 595 in the connector 540. Additionally, the illumination light coupling 601, the excitation light coupling 606, and the cooling air coupling 611 mate with and are capable of supplying, respectively, illumination light to the illumination light connection 600, excitation light to the excitation light connector (not shown), and cooling air to the cooling air connection (not shown) in the connector 540. Further, the feedback coupling 616 mates with and is capable of receiving feedback from the feedback connection 615 in the connector 540. According to an illustrative embodiment, the illumination light coupling 601 and the excitation light coupling 606 couple light from a light-emitting diode (LED) or a laser light source to, respectively, the illumination light connection 600 and the excitation light connection (not shown). One embodiment employs two white LEDs as a source for illumination light. Also illustrated in FIG. 10 are key slots 585 that may prevent the connector 540 from being connected to the receptacle 532 in an incorrect orientation.

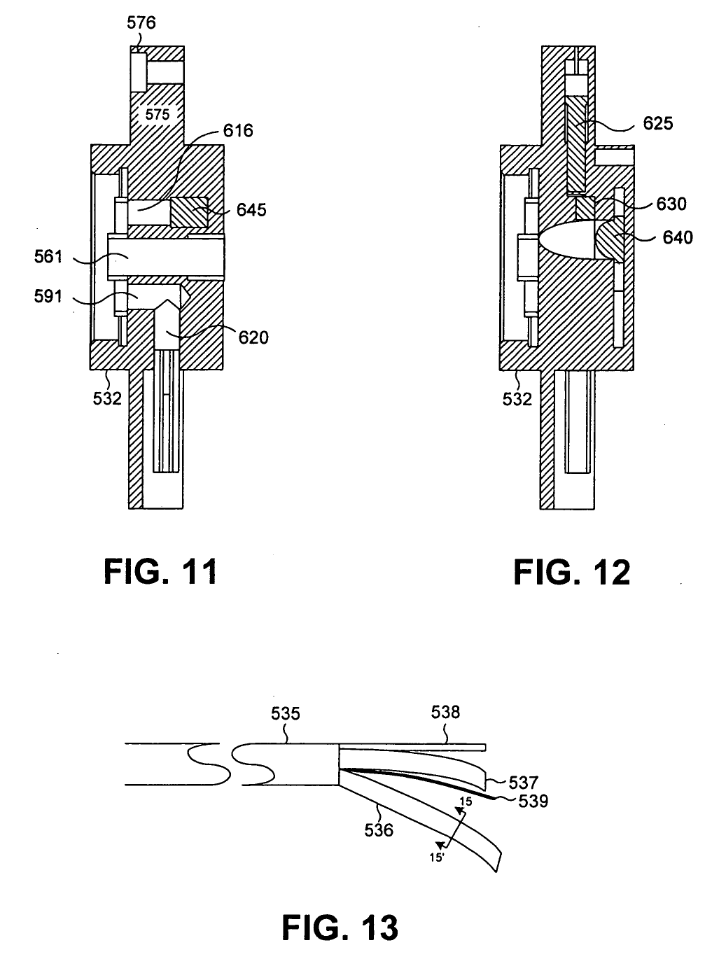

FIG. 11 is a cross-sectional view of the module illustrated in FIGS. 9 and 10. The cross-section is taken along line 11-11′ of FIG. 10, the line 11-11′ showing cross-sections of the laser energy coupling 561, the feedback coupling 616, and the spray water coupling 591. A water source 620 may supply water to the spray water coupling 591.

FIG. 12 is another cross-sectional view of the module illustrated in FIGS. 9 and 10. The cross-section of FIG. 12 is taken along line 12-12′ of FIG. 10. The diagram depicts cross-sections of a light source (e.g., an LED 640) that may be capable of supplying light to, for example, one or both of the illumination light coupling 601 (FIG. 10) and the excitation light coupling 606. A pneumatic shutter 625 may control a position of a radiation filter 630 disposed in the laser base unit 530 (FIG. 7) so that the filter is either inserted or removed from a light path originating with the light source (e.g., the LED 640). For example, one or more pneumatic shutter filters may be provided that enable switching between, for example, blue and white light that is coupled to the illumination light coupling 601 and the excitation light coupling 606 in order to enhance excitation and visualization.

FIG. 13 is a pictorial diagram of an embodiment of the conduit 535 shown in FIG. 7. The illustrated embodiment of the conduit 535 comprises a plurality of proximal members, such as, four proximal members comprising first proximal member 536, second proximal member 537, third proximal member 538, and fourth proximal member 539. First, second, and third proximal members 536, 537, and 538 may have hollow interiors configured to accommodate one or more light transmitters or other tubular or elongate structures that have cross-sectional areas less than a cross-sectional area of a hollow interior of the conduit 535. According to one embodiment, first proximal member 536 comprises an illumination fiber, second proximal member 537 comprises an excitation fiber, and third proximal member 538 comprises a feedback fiber. First, second, and third proximal members 536, 537, and 538 may be arranged such that the hollow interior of each proximal member is in communication with a hollow interior of elongate body 522 (FIG. 7). This arrangement provides for a substantially continuous path for the light transmitters to extend from the proximal portion 521 to the distal portion 550 of the laser handpiece 520 (FIG. 7). The third proximal member 538 may receive feedback (e.g., reflected or scattered light) from the laser handpiece 520 and may transmit the feedback to the laser base unit 530 as is more particularly described below.

The fourth proximal member 539 may comprise a laser energy fiber that receives laser energy derived from an Er, Cr:YSGG solid state laser disposed in the laser base unit 530 (FIG. 7). The laser may generate laser energy having a wavelength of approximately 2.78 microns at an average power of about 6 W, a repetition rate of about 20 Hz, and a pulse width of about 150 microseconds. Moreover, the laser energy may further comprise an aiming beam, such as light having a wavelength of about 655 nm and an average power of about 1 mW transmitted in a continuous-wave (CW) mode. The fourth proximal member 539 may be coupled to or may comprise the treatment optical fiber 565 (FIG. 8) that receives laser energy from the laser energy coupling 561 (FIG. 10). The fourth proximal member 539 further may transmit the laser energy received from the laser base unit 530 to the distal portion 550 of the laser handpiece 520 (FIG. 7). According to the present invention, the fourth proximal member may receive merged electromagnetic energy from a plurality of laser sources. The laser sources may be identical, or in broad, modified embodiments may be different.

Although the illustrated embodiment is provided with four proximal members, a greater or fewer number of proximal members may be provided in additional embodiments according to, for example, the number of light transmitters provided by the laser base unit 530. In addition, the illustrated embodiment includes first and second proximal members 536 and 537 that have substantially equal diameters and a third proximal member 538 that has a diameter less than either of the diameters of the first and second proximal members 536 and 537. Other configurations of diameters are also contemplated by the present invention. In an exemplary embodiment, the proximal members connect with the connections in the connector 540 illustrated in FIG. 8. For example, the first proximal member 536 may connect with the illumination light connection 600, and the second proximal member 536 may connect with the excitation light connection (not shown). The third proximal member 538 may connect with the feedback connection 615, and the fourth proximal member 539 may connect with the laser beam delivery guide connection 560 and the treatment optical fiber 565. Attachment of the proximal members 536-539 to the connections may be made internal to connector 540 in a manner known or apparent to those skilled in the art in view of this disclosure and is not illustrated in FIGS. 8 and 13.

FIG. 14 is a partial cut-away diagram of a handpiece tip 545 (cf. FIG. 7) that couples with the laser base unit 530 by means of the linking element 525 and the elongate portion 522 of the laser handpiece 520. The illustrated embodiment, which is enclosed by an outer surface 546, may receive electromagnetic (e.g., laser) energy, illumination light, excitation light and the like from the laser base unit 530. Typically, the laser energy and light are received by proximal members 536-539 (FIG. 13) as described above and transmitted through waveguides, such as fibers 705 disposed in the elongate portion 522 and the handpiece tip 545 as described below with reference to FIG. 16. According to one embodiment, laser energy 701 is received (e.g., through fourth proximal member 539 (FIG. 13)), carried by an internal waveguide such as treatment optical fiber 700, and directed toward a first mirror 720 disposed in the distal portion 550 of the handpiece tip 545, whence reflected laser energy is directed toward the fiber tip 555. The fiber tip 555, which may be configured (e.g., sized and shaped) for merged-output or standard operation, may be encased in a tip ferrule 605 that, together with the fiber tip 555, forms a removable, interchangeable unit as is described more fully in co-pending U.S. application Ser. No. 11/231,306, filed Sep. 19, 2005 and entitled OUTPUT ATTACHMENTS CODED FOR USE WITH ELECTROMAGNETIC-ENERGY PROCEDURAL DEVICE (Att. Docket BI9804P), the entire contents of which are included herein by reference to the extent not mutually incompatible.

Illumination light (not shown), for example, further may be received by the handpiece tip 545, such as from proximal members 536 and 537 (FIG. 13), carried by fibers 705 (FIG. 16, not shown in FIG. 14), and directed toward a second mirror 725, likewise disposed within the distal portion 550 of the handpiece tip 545. The second mirror 725 directs the light toward a plurality of tip waveguides 730 as is more particularly described below with reference to FIG. 18. Light exiting the tip waveguides 730 may illuminate a target area. In some embodiments, first and second mirrors 720 and 725 may comprise parabolic, toroidal, and/or flat surfaces. FIG. 14 also illustrates a simplified view of a path 745 of cooling air.

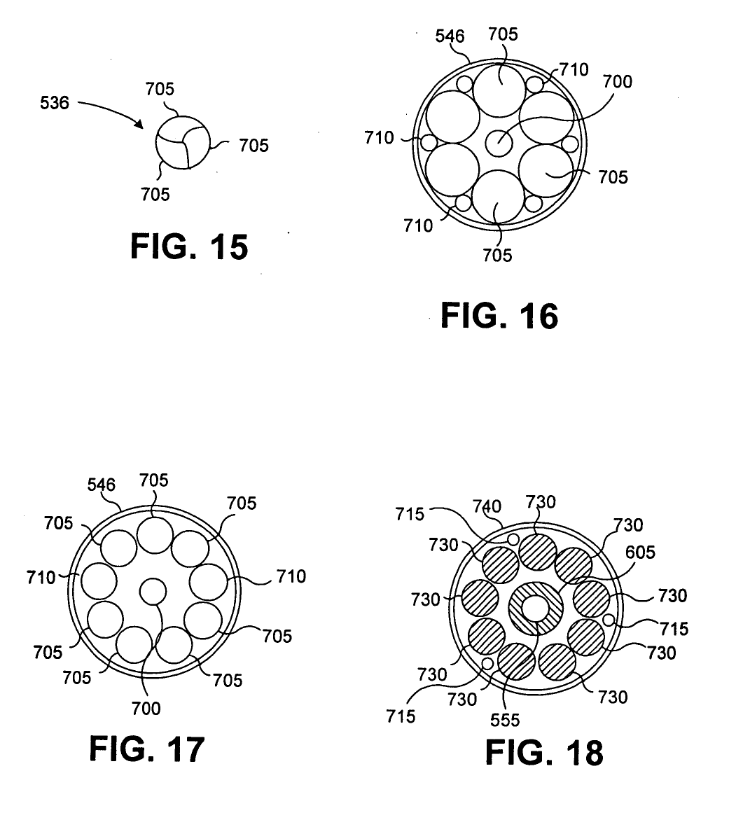

FIG. 15 is a cross-sectional view of first proximal member 536 taken along line 15-15′ of FIG. 13 demonstrating that first proximal member 536 (as well as, optionally, second proximal member 537) may comprise three optical fibers 705 substantially fused together to define a unitary light emitting assembly or waveguide. In modified embodiments, the three optical fibers 705 may be joined by other means or not joined. According to other embodiments, one or more of the proximal members, such as the second proximal member 537, can include different numbers of optical fibers 705. In an illustrated embodiment, the second proximal member 537 can include six optical fibers 705 (FIG. 15) that begin to separate and eventually (e.g., at line 16-16′ in FIG. 14) surround a laser energy waveguide, such as treatment optical fiber 700, as illustrated in a cross-sectional view of FIG. 16 taken along line 16-16′ of FIG. 14 in the handpiece tip 545. In another exemplary embodiment, the second proximal member 537 can include three optical fibers 705 (FIG. 15) and the first proximal member 536 can include three optical fibers 705 (FIG. 15), all six of which begin to separate and eventually (e.g., at line 16-16′ in FIG. 14) surround a laser energy waveguide, such as treatment optical fiber 700 in the handpiece tip 545.

The third proximal member 538 may include six relatively smaller fibers 710, as likewise is shown in the cross-sectional view of FIG. 16. Additional waveguides, such as additional fibers 710, may be disposed within the outer surface 546 and, further, may be configured to receive feedback from a target surface. For example, feedback may comprise scattered light 735 (FIG. 14) received from the fiber tip 555 in a manner more particularly described below. The scattered light 735 (i.e., feedback light) may be transmitted by third proximal member 538 (FIG. 13) to the laser base unit 530 (FIG. 7). Fibers 710 are illustrated in FIG. 16 as being separate from each other, but in additional embodiments two or more of the fibers 710 can be fused or otherwise joined together. Fibers 705 and 710 can be manufactured from plastic using conventional techniques, such as extrusion and the like.

FIG. 17 is a cross-sectional diagram of another embodiment of the handpiece tip 545, the cross-section being taken along line 16-16′ in FIG. 14. FIG. 17 depicts a laser energy waveguide, such as treatment optical fiber 700 surrounded by illumination waveguides, such as fibers 705, and feedback waveguides, such as fibers 710, all of which are disposed within outer surface 546. In a manner similar to that described above with reference to FIG. 16, the illumination waveguides, such as fibers 705 may receive light energy from the laser base unit 530 (FIG. 7) by way of illumination light coupling 601 (FIG. 4), illumination light connection 600 (FIG. 8), and, for example, proximal members 536 and/or 537 (FIG. 13); and fibers 705 may direct the light to the distal portion 550 of the handpiece tip 545 (FIG. 14).

In certain implementations involving, for example, caries detection, as disclosed in a co-pending U.S. application Ser. No. 11/203,399, filed Aug. 12, 2005 and entitled CARIES DETECTION USING TIMING DIFFERENTAILS BETWEEN EXCITATION AND RETURN PULSES (Att. Docket BI9805P), the entire contents of which are incorporated herein by reference, fibers 705 further may function as both illumination and excitation waveguides. Feedback waveguides, such as fibers 710, may receive feedback light from the fiber tip 555 (FIG. 14) and may transmit the feedback light to third proximal member 538, which couples to or comprises feedback connection 615. The feedback light may be received by the feedback coupling 616, which transmits the light to a feedback detector 645 (FIG. 11) disposed in the laser base unit 530 (FIG. 7). In other embodiments, described more fully in the above-referenced co-pending U.S. application Ser. No. 11/192,334, filed Jul. 27, 2005 and entitled IDENTIFICATION CONNECTOR FOR A MEDICAL LASER HANDPIECE (Att. Docket BI9802P), the laser base unit 530 may additionally supply spray air, spray water, and cooling air to the laser handpiece 520.

FIG. 18 is a cross-sectional diagram of another embodiment of the laser handpiece tip 545 taken along line 18-18′ of FIG. 14. This embodiment illustrates a fiber tip 555 surrounded by a tip ferrule or sleeve 605, and, optionally, glue that fills a cavity 630 around the fiber tip 555 to hold the fiber tip 555 in place. Tip waveguides 730 may receive illumination light from second mirror 725 (FIG. 14) and direct the illumination light to a target. In some embodiments, fluid outputs 715, which are disposed in the handpiece tip 545, may carry, for example, air and water. More particularly, illumination light exiting from the illumination fibers 705 (cf. FIG. 17) is reflected by second mirror 725 (FIG. 14) into the tip waveguides 730 (FIGS. 14 and 18). While a portion of this illumination light may also be reflected by second mirror 725 (FIG. 14) into fiber tip 555, fiber tip 555 receives, primarily, a relatively high level of laser energy 701 from treatment optical fiber 700 (cf. FIG. 17), which laser energy, as presently embodied, comprises radiation including both a cutting beam and an aiming beam. In a representative embodiment, illumination light from the illumination fibers 705 that exits the tip waveguides 730 is white light of variable intensity (e.g., adjustable by a user) for facilitating viewing and close examination of individual places of a target surface, such as a tooth. For example, a cavity in a tooth may be closely examined and treated with the aid of light from a plurality of tip waveguides 730.

A detailed illustration of an embodiment of a chamber for mixing spray air and spray water in the handpiece tip 545 is shown in FIG. 14a. As illustrated, the mixing chamber comprises an air intake 713 connected to, for example, tubing (not shown) that connects to and receives air from, the spray air connection 595 in the connector 540 (FIG. 8). Similarly, a water intake 714 may connect to tubing (also not shown) that connects to and receives water from the spray water connection 590 in the connector 540 (FIG. 8). The air intake 713 and the water intake 714, which may have circular cross-sections about 250 μm in diameter, join at an angle 712 that may approximate 110° in a typical embodiment. Mixing may occur in a neighborhood where the air intake 713 and water intake 714 join, and a spray (e.g., atomized) mixture 716 of water and air may be ejected through a fluid output 715. The embodiment illustrated in FIG. 18 depicts three fluid outputs 715. These fluid outputs may, for example, correspond to, comprise parts of, or comprise substantially all of, any of fluid outputs described in U.S. application Ser. No. 11/042,824, filed Jan. 24, 2005 and entitled ELECTROMAGNETICALLY INDUCED CUTTER AND METHOD (Att. Docket BI9768P), the entire contents of which are incorporated herein by reference, to the extent compatible, or, in other embodiments, structures described in the referenced provisional patent application may be modified to be compatible with the present invention. The fluid outputs 715 may, as illustrated in FIGS. 14 and 18, have circular cross-sections measuring about 350 μm in diameter.

Scattering of light as described above with reference to FIG. 13 can be detected and analyzed to monitor various conditions. For example, scattering of an aiming beam can be detected and analyzed to monitor, for example, integrity of optical components that transmit the cutting and aiming beams. In typical implementations the aiming beam may cause little to no reflection back into the feedback fibers 710. However, if any components (such as, for example, mirror 720 or fiber tip 555) is damaged, scattering of the aiming beam light (which may be red in exemplary embodiments) may occur. Scattered light 735 (FIG. 14) may be directed by the second mirror 725 into feedback fibers 710 that may convey the scattered light to the laser base unit 530 (FIG. 7).

The present invention contemplates constructions and uses of visual feedback implements (e.g., cameras) as described in, for example, U.S. Provisional Application No. 60/688,109, filed Jun. 6, 2005 and entitled ELECTROMAGNETIC RADIATION EMITTING TOOTHBRUSH AND DENTIFRICE SYSTEM (Att. Docket BI9887PR), and U.S. Provisional Application No. 60/687,991, filed Jun. 6, 2005 and entitled METHODS FOR TREATING EYE CONDITIONS (Att. Docket BI9879PR), on (e.g., attached) or in a vicinity of (e.g., on or near, attached or not, output ends) of electromagnetic energy output devices (e.g., lasers and dental lasers), wherein such output devices, constructions and uses can be, in whole or in part, including any associated methods, modifications, combinations, permutations, and alterations of any constructions(s) or use(s) described or referenced herein or recognizable as included or includable in view of that described or referenced herein by one skilled in the art, to the extent not mutually exclusive, as described in U.S. application Ser. No. 11/033,032, filed Jan. 10, 2005 and entitled ELECTROMAGNETIC ENERGY DISTRIBUTIONS FOR ELECTROMAGNETICALLY INDUCED DISRUPTIVE CUTTING (Att. Docket BI9842P), U.S. application Ser. No. 11/033,043, filed Jan. 10, 2005 and entitled TISSUE REMOVER AND METHOD (Att. Docket BI9830P), U.S. application Ser. No. 11/203,400, filed Aug. 12, 2005 and entitled DUAL PULSE-WIDTH MEDICAL LASER WITH PRESETS (Att. Docket BI9808P), U.S. application Ser. No. 11/203,677, filed Aug. 12, 2005 and entitled LASER HANDPIECE ARCHITECTURE AND METHODS (Att. Docket BI9806P), and U.S. application Ser. No. 09/848,010, filed May 2, 2001 and entitled DERMATOLOGICAL CUTTING AND ABLATING DEVICE (Att. Docket BI9485P), the entire contents of all which are incorporated herein by reference. In some embodiments, a sensor, which may comprise one or more visual feedback implements, may be introduced. The visual feedback implement can be used, for example, (a) in a form that is integrated into a handpiece or output end of an electromagnetic energy output device, (b) in a form that is attached to the handpiece or electromagnetic energy output device, or (c) in conjunction with (e.g., not attached to) the handpiece or electromagnetic energy output device, wherein such handpieces and devices can facilitate cutting, ablating, treatments, and the like. In broad, modified embodiments, treatments can include, for example, low-level light treatments using merged-output or standard electromagnetic energy such as described in the above referenced U.S. Provisional Application No. 60/687,991 and U.S. Provisional Application No. 60/687,256, filed Jun. 3, 2005 and entitled TISSUE TREATMENT DEVICE AND METHOD (Att. Docket BI9846), the entire contents of which are expressly incorporated herein by reference.

For example, one implementation may be useful for, among other things, optimizing, monitoring, or maximizing a cutting effect of an electromagnetic energy emitting device, such as a laser handpiece. The merged laser output can be directed, for example, from a waveguide (e.g., one fiber optic and/or output tip), such as a power fiber, into fluid (e.g., an air and/or water spray, fluid particles, or an atomized distribution of fluid particles from a water connection and/or a spray connection near an output end of the handpiece) that is emitted from a fluid output of the handpiece above a target surface. The fluid output may comprise a plurality of fluid outputs, concentrically arranged around a power fiber, as described in, for example, the above-referenced U.S. application Ser. No. 11/042,824 and U.S. application Ser. No. 11/231,306. The power fiber may comprise, for example, an enlarged treatment optical fiber as described herein. An apparatus including corresponding structure for directing electromagnetic energy into an atomized distribution of fluid particles above a target surface is disclosed, for example, in the above-referenced U.S. Pat. No. 5,574,247. Large amounts of laser energy, for example, can be imparted into the fluid (e.g., atomized fluid particles), which can comprise water, to thereby expand the fluid (e.g., fluid particles) and apply disruptive (e.g., mechanical) cutting forces to the target surface. In the case of a merged-output mode of operation, the size (e.g., area or volume) of an interaction zone may be increased, using the same analysis as provided above for the provision of enlarged spot sizes in merged-output modes. Thus, for example, the cross-sectional diameter of the relatively large spot size, measured in a direction transverse to a direction of propagation of the merged electromagnetic energy, projected into an interaction zone can be greater than a reference spot-size associated with a pre-configuration electromagnetic energy emitting device. In one example, the relatively large spot size can be about 1.1 to 2 times the reference spot size (e.g., for two, or more, merged treatment beams), and in a particular embodiment the relatively large spot size may be two times larger (e.g., for a merged beam from two treatment beams) than a spot size associated with a pre-configuration electromagnetic energy emitting device. The relatively large spot size can be selected to have a fluence or power density of electromagnetic energy that would correspond to or equal a reference fluence or power density of a single electromagnetic energy emitting device implementing the procedure in isolation or in a non-merged mode of operation. During a procedure, such as an oral procedure where access and visibility are limited, careful and close-up monitoring by way of a visual feedback implement of (a) interactions between the electromagnetic energy and the fluid (e.g., above the target surface) and/or (b) cutting, ablating, treating or other impartations of disruptive surfaces to the target surface, can improve a quality of the procedure.

In certain embodiments, visualization optical fibers (e.g., a coherent fiber bundle) can be provided that are configured to transmit light from the distal portion 550 to the proximal portion 521 of the laser handpiece 520 (FIG. 7) for routing images (e.g., working-surface images) acquired at or in a vicinity of the distal portion by a visual feedback implement. According to some embodiments, the visual feedback implement can comprise an image-acquisition device (e.g., CCD or CMOS camera) for obtaining or processing images from the distal portion. The visual feedback implement can be built-in or attached (e.g., removably attached) to the handpiece and, further, can be disposed at various locations on or in connection with the handpiece between the proximal portion and distal portion, or proximally of the proximal portion. According to this and any of the other embodiments described herein, one or more of the optical fibers described herein and the visualization optical fibers can be arranged, for example, outside of the handpiece envelope. A few applications for the presently-described visual feedback implement may include periodontal pockets (e.g., diagnostic and treatment), endodontics (e.g., visualization of canals), micro-dentistry, tunnel preparations, caries detection and treatment, bacteria visualization and treatment, general dentistry, and airborne-agent and gas detection applications as described in the above-referenced U.S. Provisional Application No. 60/688,109.

According to another embodiment of the present invention, electromagnetic radiation (e.g., one or more of blue light, white light, infrared light, a laser beam, reflected/scattered light, fluorescent light, and the like, in any combination) may be transmitted in one or both directions through one or more of the fibers described herein (e.g., feedback, illumination, excitation, treatment), in any combination. Outgoing and incoming beams of electromagnetic radiation can be separated or split, for example, according to one or more characteristics thereof, at the proximal portion or laser base unit using a beam splitter, such as a wavelength-selective beam splitter (not shown), in a manner known to those skilled in the art.

In a representative embodiment, the fluid outputs 715 (FIG. 18) are spaced at zero (a first reference), one hundred twenty, and two hundred forty degrees. In another embodiment, the six illumination/excitation fibers 705 and three feedback fibers 710 (FIG. 17) are optically aligned with and coupled via second mirror 725 on, for example, a one-to-one basis, to nine tip waveguides 730 (FIGS. 14 and 18). For example, if nine elements (e.g., six illumination/excitation fibers 705 and three feedback fibers 710) are evenly spaced and disposed at zero (a second reference, which may be the same as or different from the first reference), forty, eighty, one hundred twenty, one hundred sixty, two hundred, two hundred forty, two hundred eighty, and three hundred twenty degrees, then nine tip waveguides 730 may likewise be evenly spaced and disposed at zero, forty, eighty, one hundred twenty, one hundred sixty, two hundred, two hundred forty, two hundred eighty, and three hundred twenty degrees. In another embodiment wherein, for example, the tip waveguides 730 are arranged in relatively closely-spaced groups of three with each group being disposed between two fluid outputs, the tip waveguides 730 may be disposed at, for example, about zero, thirty-five, seventy, one hundred twenty, one hundred fifty-five, one hundred ninety, two hundred forty, two hundred seventy-five, and three hundred ten degrees. In one such embodiment, the tip waveguides 730 may likewise be disposed at about zero, thirty-five, seventy, one hundred twenty, one hundred fifty-five, one hundred ninety, two hundred forty, two hundred seventy-five, and three hundred ten degrees. Further, in such an embodiment, the fluid outputs may be disposed between the groups of tip waveguides at about ninety-five, two hundred fifteen, and three hundred thirty-five degrees.

The cross-sectional views of FIGS. 16 and 17 may alternatively (or additionally), without being changed, correspond to cross-sectional lines 16-16′ taken in FIG. 14 closer to (or next to) first and second mirrors 720 and 725 to elucidate corresponding structure that outputs radiation distally onto the first mirror 720 and the second mirror 725. The diameters of illumination/excitation fibers 705 and feedback fibers 710 may be different as illustrated in FIG. 16 or the diameters may be the same or substantially the same as shown in FIG. 17. In an exemplary embodiment, the illumination/excitation fibers 705 and feedback fibers 710 in FIG. 17 comprise plastic constructions with diameters of about 1 mm, and the tip waveguides 730 in FIGS. 14 and 18 comprise sapphire constructions with diameters of about 0.9 mm.

By way of the disclosure herein, a handpiece has been described that utilizes merged electromagnetic energy to affect a target surface. In the case of dental procedures using merged laser energy, the handpiece can include an optical fiber for transmitting merged laser energy to a target surface for treating (e.g., ablating) a dental structure, such as a tooth, a plurality of optical fibers for transmitting light (e.g., blue light) for illumination, curing, whitening, and/or diagnostics of a tooth, a plurality of optical fibers for transmitting light (e.g., white light) to a tooth to provide illumination of the target surface, and a plurality of optical fibers for transmitting light from the target surface back to a sensor for analysis. In the illustrated embodiment, the optical fibers that transmit blue light also transmit white light. In accordance with one aspect of the invention herein disclosed, a handpiece comprises an illumination tube having a feedback signal end and a double mirror handpiece.

One aspect of the present invention, as outlined in User Manual for a WATERLASE® All-Tissue Laser for Dentistry (referenced herein as “the incorporated WATERLASE® User Manual”), the entire contents of which are incorporated herein by reference, includes programmed parameter values referred to herein as presets, the presets being applicable to various surgical procedures. Presets may be programmed at a time of manufacture of a device, in which case the presets may be referred to as pre-programmed presets. Alternatively or additionally, presets may be generated or modified and stored by an end user. Table 2 of the incorporated WATERLASE® User Manual is reproduced herein as Table 1 and includes examples of pre-programmed presets for general hard and soft tissue procedures.

TABLE 1
Suggested Presets for General Hard and Soft Tissue Procedures

| | | | | Energy | | |
|---|---|---|---|---|---|---|
| | | | Rep | Per | Water | Air |
| | | Power | Rate | pulse | Setting | Setting |
| Preset # | Procedure | (Watts) | (Hz) | (mJ) | (%) | (%) |
| 1 | Enamel Cutting | 6.0 | 20 | 300 | 75 | 90 |
| 2 | Dentin Cutting | 4.0 | 20 | 200 | 55 | 65 |
| 3 | Soft Tissue | 1.5 | 20 | 75 | 7 | 11 |
| | Cutting (thin | | | | | |
| | tissue, small | | | | | |
| | incisions) | | | | | |
| 4 | Soft Tissue | 0.75 | 20 | 37.5 | 0 | 11 |
| | Coagulation | | | | | |

Referring to Table 1, any of the listed combinations of parameters, or variations thereof, may be implemented with any of the merged-output implementations described herein. In simple exemplary implementations, presets 1 to 4 may be implemented with a merged-output formed from two treatment beams and a corresponding enlarged spot size of 1.1 or more times (e.g., 2 times) the reference spot size, wherein, for example, the fluence or power density may be the same as the reference fluence or power density. The percent air setting and percent water setting values set forth therein may be directed to one or more fluid outputs (cf. 715 of FIGS. 14, 14a and 18) at pressures ranging from about 5 pounds per square inch (psi) to about 60 psi and at flow rates ranging from about 0.5 liters/minute to about 20 liters/minute. A liquid (e.g., water) may be directed to one or more of the fluid outputs 380 at pressures ranging from about 5 psi to about 60 psi and at flow rates ranging from about 2 milliliters (ml)/minute to about 100 ml/minute. In other embodiments, the air flow rate can go as low as about 0.001 liters/minute, and/or the liquid flow rate can go as low as about 0.001 ml/minute. In certain implementations, a water flow rate through a water line disposed in the laser handpiece 520 (FIG. 7) may be about 84 ml/minute (e.g., 100%), and an air flow rate through an air line of the laser handpiece 520 may be about 13 liters/minute (e.g., 100%). These values may be understood in reference to such flow rates or to other flow rates suggested in the incorporated WATERLASE® User Manual or otherwise known to those skilled in the art in the same context.

In typical embodiments of the merged-output system, wherein electromagnetic energy emitting devices forming the merged-output system have given settings for a given application or procedure as described above, for example, with reference to Table 1, the diameters of the waveguides may be greater than diameters of waveguides that would typically be used with the individual electromagnetic energy emitting devices when the devices are used individually in a non-merged mode and configured with the given settings for the given application or procedure. In other words, the diameters of the waveguides carrying merged beams of a merged-output system may be larger than diameters used for the devices (i.e., the pre-configuration electromagnetic energy emitting devices forming the merged-output system) when operated individually at substantially the same settings as when operated as a part of the merged-output system and/or when used to perform the same application or procedure.

In certain embodiments, the methods and apparatuses of the above embodiments can be configured and implemented for use, to the extent compatible and/or not mutually exclusive, with existing technologies including any of the above-referenced apparatuses and methods. Corresponding or related structure and methods described in the following patents assigned to BioLase Technology, Inc., are incorporated herein by reference in their entireties, wherein such incorporation includes corresponding or related structure (and modifications thereof) in the following patents which may be (i) operable with, (ii) modified by one skilled in the art to be operable with, and/or (iii) implemented/used with or in combination with any part(s) of, the present invention according to this disclosure, that/those of the patents, and the knowledge and judgment of one skilled in the art: U.S. Pat. No. 6,829,427 entitled FIBER DETECTOR APPARATUS AND RELATED METHODS, U.S. Pat. No. 6,821,272 entitled ELECTROMAGNETIC ENERGY DISTRIBUTIONS FOR ELECTROMAGNETICALLY INDUCED CUTTING, U.S. Pat. No. 6,744,790 entitled DEVICE FOR REDUCTION OF THERMAL LENSING, U.S. Pat. No. 6,669,685 entitled TISSUE REMOVER AND METHOD, U.S. Pat. No. 6,616,451 entitled ELECTROMAGNETIC RADIATION EMITTING TOOTHBRUSH AND DENTIFRICE SYSTEM, U.S. Pat. No. 6,616,447 entitled DEVICE FOR DENTAL CARE AND WHITENING, U.S. Pat. No. 6,610,053 entitled METHODS OF USING ATOMIZED PARTICLES FOR ELECTROMAGNETICALLY INDUCED CUTTING, U.S. Pat. No. 6,567,582 entitled FIBER TIP FLUID OUTPUT DEVICE, U.S. Pat. No. 6,561,803 entitled FLUID CONDITIONING SYSTEM, U.S. Pat. No. 6,544,256 entitled ELECTROMAGNETICALLY INDUCED CUTTING WITH ATOMIZED FLUID PARTICLES FOR DERMATOLOGICAL APPLICATIONS, U.S. Pat. No. 6,533,775 entitled LIGHT-ACTIVATED HAIR TREATMENT AND REMOVAL DEVICE, U.S. Pat. No. 6,389,193 entitled ROTATING HANDPIECE, U.S. Pat. No. 6,350,123 entitled FLUID CONDITIONING SYSTEM, U.S. Pat. No. 6,288,499 entitled ELECTROMAGNETIC ENERGY DISTRIBUTIONS FOR ELECTROMAGNETICALLY INDUCED MECHANICAL CUTTING, U.S. Pat. No. 6,254,597 entitled TISSUE REMOVER AND METHOD, U.S. Pat. No. 6,231,567 entitled MATERIAL REMOVER AND METHOD, U.S. Pat. No. 6,086,367 entitled DENTAL AND MEDICAL PROCEDURES EMPLOYING LASER RADIATION, U.S. Pat. No. 5,968,037 entitled USER PROGRAMMABLE COMBINATION OF ATOMIZED PARTICLES FOR ELECTROMAGNETICALLY INDUCED CUTTING, U.S. Pat. No. 5,785,521 entitled FLUID CONDITIONING SYSTEM, and U.S. Pat. No. 5,741,247 entitled ATOMIZED FLUID PARTICLES FOR ELECTROMAGNETICALLY INDUCED CUTTING, all of which are commonly assigned and the entire contents of which are incorporated herein by reference.

Also, the above disclosure is intended to be operable with device(s) described in the incorporated WATERLASE® User Manual, in the provisional application filed Jul. 13, 2004 and entitled FIBER TIP DETECTOR APPARATUS, the provisional application filed Jul. 20, 2004 and entitled CONTRA-ANGLE ROTATING HANDPIECE HAVING TACTILE-FEEDBACK TIP FERRULE, the provisional applications filed Jul. 27, 2004 and entitled DUAL PULSE-WIDTH MEDICAL LASER, MEDICAL LASER HAVING DUAL-TEMPERATURE FLUID OUTPUT, and IDENTIFICATION CONNECTOR, and the provisional applications filed Aug. 12, 2004 and entitled CARIES DETECTION USING TIMING DIFFERENTAILS BETWEEN EXCITATION AND RETURN PULSES and DUAL PULSE-WIDTH MEDICAL LASER WITH PRESETS, which are all commonly assigned. All of the contents of the preceding materials are incorporated herein by reference.

While this invention has been described with respect to various specific examples and embodiments, it is to be understood that the invention is not limited thereto and that it can be variously practiced. Multiple variations, combinations and modifications to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. Accordingly, the present invention is not intended to be limited by the disclosed embodiments, but is to be defined by reference to the appended claims.

What is claimed is:

1. A method of increasing a spot size projected on or into a target by an electromagnetic energy emitting device, the method comprising:
providing a plurality of treatment electromagnetic energies, each being capable of illuminating the target with a treatment electromagnetic energy having a reference power density and a reference spot size; and
merging the plurality of treatment electromagnetic energies, thereby forming merged electromagnetic energy on or into the target, the merged electromagnetic energy having a power density that is about the same as a largest one of the corresponding reference power densities and having a spot size that is greater than a largest one of the corresponding reference spot sizes.

2. The method as set forth in claim 1, wherein the merging comprises directing the treatment electromagnetic energies to a merging device, an output from which comprises the merged electromagnetic energy.

3. The method as set forth in claim 1, wherein the merging comprises directing the treatment electromagnetic energies to optics capable of producing an output comprising the merged electromagnetic energy.

4. The method as set forth in claim 3, wherein the directing comprises directing the merged electromagnetic energy to a waveguide, whereby the waveguide directs the merged electromagnetic energy to the target.

5. The method as set forth in claim 3, wherein the directing does not include use of a waveguide.

6. The method as set forth in claim 1, wherein:
the merging comprises directing the treatment electromagnetic energies to inputs of a plurality of first waveguides having reference cross-sectional areas;
outputs of the plurality of first waveguides are directed to one or more second waveguides fewer in number but greater in cross-sectional area than the plurality of first waveguides; and
an output of the one or more second waveguides comprises the merged electromagnetic energy.

7. The method as set forth in claim 6, wherein:
the directing of the treatment electromagnetic energies comprises directing treatment electromagnetic energies emitted by two electromagnetic energy emitting devices;
the plurality of first waveguides comprises two waveguides; and
the one or more second waveguides comprise one waveguide having a cross-sectional area about twice as large as the largest corresponding cross-sectional area of the plurality of first waveguides.

8. The method as set forth in claim 6, wherein:
the directing of the treatment electromagnetic energies comprises directing treatment electromagnetic energies emitted by three electromagnetic energy emitting devices;
the plurality of first waveguides comprises three waveguides; and
the one or more second waveguides comprise one or two waveguides each having a cross-sectional area greater than the largest corresponding cross-sectional area of the plurality of first waveguides.

9. An apparatus for increasing a spot size formed on or into a target by electromagnetic energy, the apparatus comprising:
a plurality of electromagnetic energy outputs, each being capable of illuminating the target with treatment electromagnetic energy having a reference power density and a reference spot size; and
a merging device capable of merging the treatment electromagnetic energies emitted by the plurality of electromagnetic energy outputs, to thereby form merged electromagnetic energy on or into the target, the merged electromagnetic energy having a power density that is about the same as a largest one of the corresponding reference power densities and having a spot size that is greater than a largest one of the corresponding reference spot sizes.

10. The apparatus as set forth in claim 9, wherein the merging device comprises:
a plurality of waveguide inputs capable of receiving treatment electromagnetic energy from the plurality of electromagnetic energy outputs; and
at least one waveguide output capable of conveying the merged electromagnetic energy to the target.

11. The apparatus as set forth in claim 10, wherein:
the plurality of electromagnetic energy outputs comprises two electromagnetic energy outputs;
the plurality of waveguide inputs comprises two waveguide inputs; and
the at least one waveguide output comprises one waveguide output.

12. The apparatus as set forth in claim 11, wherein the spot size is about twice as large as the largest one of the corresponding reference spot sizes.

13. The apparatus as set forth in claim 11, wherein:
the two electromagnetic energy outputs are a first electromagnetic energy output and a second electromagnetic energy output;
the first electromagnetic energy output emits treatment electromagnetic energy having a first wavelength effective for ablating hard tissue; and
the second electromagnetic energy output emits treatment electromagnetic energy having a second wavelength different from the first wavelength but having about the same efficacy at ablating hard tissue.

14. The apparatus as set forth in claim 13, wherein each of the first and second wavelengths is selected from a group consisting of an A-wavelength ranging from about 2.70 to about 2.80 microns, a B-wavelength of about 2.69 microns, and a C-wavelength of about 2.94 microns.

15. The apparatus as set forth in claim 13, wherein:
the two electromagnetic energy outputs are a first electromagnetic energy emitting output and a second electromagnetic energy output;
the first electromagnetic energy output emits treatment electromagnetic energy having a first wavelength;
the second electromagnetic energy output emits treatment electromagnetic energy having a second wavelength; and
the first wavelength is about equal to the second wavelength.

16. The apparatus as set forth in claim 9, wherein the merging device comprises optics capable of receiving treatment electromagnetic energy from the plurality of electromagnetic energy outputs.

17. The apparatus as set forth in claim 9, wherein the electromagnetic energy outputs are laser outputs, the treatment electromagnetic energy is treatment laser light, and the merged electromagnetic energy is merged laser light.

18. The apparatus as set forth in claim 17, wherein the merging device comprises:
a plurality of waveguide inputs capable of receiving treatment laser beams from the plurality of laser outputs; and
at least one waveguide output capable of directing the merged laser light to the target.

19. The apparatus as set forth in claim 17, wherein:
the plurality of laser outputs comprises two laser outputs; and
the at least one merged laser beam is a single merged laser beam.

20. The apparatus as set forth in claim 19, wherein:
the merging device comprises optics capable of receiving laser beams from the two laser outputs; and
the optics direct the merged laser beam to an input waveguide.

21. The apparatus as set forth in claim 17, wherein:
the plurality of laser outputs comprises three laser outputs; and
the at least one merged laser beam comprises one or two merged laser beams.

22. The apparatus as set forth in claim 21, wherein:
the merging device comprises optics capable of receiving laser beams from the three laser outputs; and
the optics direct the one or two merged laser beams to inputs of one or two waveguides.

23. The apparatus as set forth in claim 17, wherein the plurality of laser outputs comprises:
a first laser output that emits treatment laser light having a first wavelength; and
a second laser output that emits treatment laser light having a second wavelength which is about the same as the first wavelength.
